(19) United States
(12) Patent Application Publication
(10) Pub. No.: US 2008/0145676 A1
(43) Pub. Date: Jun. 19, 2008

(54) Crosslinkable, Silane-Modified Copolymers

(75) Inventors: Oliver Minge, Munchen (DE); Hans-Peter Weitzel, Reischach (DE); Richard Weidner, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/813,294

(22) PCT Filed: Dec. 22, 2005
(86) PCT No.: PCT/EP2005/013937

§ 371 Date: Jul. 11, 2007

(30) Foreign Application Priority Data
Jan. 5, 2005 (DE) 10 2005 000 823.2

(51) Int. Cl. C08F 30/08; C04B 24/42; B32B 27/06

(52) U.S. Cl. 428/447; 526/279; 524/3

(57) ABSTRACT

Crosslinkable silane-modified copolymers are prepared by copolymerizing free radically polymerizable monomers with an ethylenically unsaturated α-silane. The copolymers exhibit high storage stability coupled with rapid cure.

The invention relates to crosslinkable, silane-modified copolymers in the form of their aqueous polymer dispersions or water-redispersible polymer powders obtainable by means of free-radically initiated copolymerization in aqueous medium of ethylenically unsaturated monomers with an after-crosslinking ethylenically unsaturated silane comonomer, and, if desired, subsequent drying of the resultant polymer dispersion.

Polymers prepared by free-radical copolymerization of one or more olefinic monomers with silane-containing, aqueously crosslinkable olefinic monomers, examples being vinyltrialkoxy-silane, vinyltriacetoxysilane and γ-(meth)acryloyloxypropyl-trialkoxysilane, serve as a basis for adhesives, sealing materials, inks or coating materials in such different fields of application as cosmetology, adhesive bonding, for finishing textiles, wood, paper or metal, in the construction sector or in the printing sector. The incorporation of silyl functionalities of this kind allows the polymer to undergo post-curing after application (filming, for example), since the free silanol functions which form as a result of hydrolysis and, in so doing, give off low molecular mass compounds such as alcohol or acetic acid, for example, undergo condensation to build up a dense network of siloxane units.

In order to be able to rule out hazard to health and environment from the use of solvents, and to be able to comply with statutory requirements relating to VOC limits, the trend for some years already has been going in the direction of aqueous systems, which are generally obtained by means of emulsion or suspension polymerization. The preparation of aqueous, post-crosslinkable polymer dispersions of this kind has already been known for a long time and was described, for example, in U.S. Pat. No. 3,706,697. There, crosslinkable acrylate copolymers having alkoxysilane-functional groups are prepared by copolymerization of γ-(meth)acryloyloxyalkyltrialkoxysilane.

A disadvantage encountered again and again, however, is the often low storage stability of the dispersions obtained, since owing to the presence of alkoxysilyl functionalities these dispersions are inherently susceptible to hydrolysis and condensation reactions. Additionally, for the same reason, there is a pronounced sensitivity towards an acidic and basic environment.

Attempted solutions for preventing this premature crosslinking had already been around before the present time: for instance, U.S. Pat. No. 4,526,930 and U.S. Pat. No. 5,827,922 describe the use of alkoxysilanes having sterically bulky substitution patterns for preparing aqueous polymer dispersions which, on account of the steric shielding of the Si centre, exhibit an increased stability to hydrolysis and hence an increased storability. The polymer can both be dispersed subsequently in the aqueous phase and be prepared in disperse form by means of copolymerization in emulsion. The two major drawbacks of the use of sterically hindered alkoxysilanes in accordance with the above method are the high costs of the corresponding monomeric silane building blocks and the fact that the silanes are already so unreactive in respect of a hydrolysis that they require an organotin- or organotitanium-based crosslinking catalyst, which from a toxicological standpoint ought likewise to be avoided.

The monomers nowadays used to produce silane-crosslinking polymer dispersions therefore originate in general from the groups of the vinyltrialkoxysilanes or of the γ-(meth)acryloyl-oxypropyltrialkoxysilanes. Examples of typical representatives include vinyltriethoxysilane or γ-(meth)acryloyloxypropyl-trimethoxysilane.

Polymer dispersions modified with vinyl-substituted silanes as monomer units find use, for example, as paint binders, such as in EP 1153979 A2, or as architectural preservatives, as described in DE-A 2148457. There, copolymers with vinyl-trialkoxysilane and γ-(meth)acryloyloxyalkyltrialkoxysilane units are used not for crosslinking but rather for improving the wet adhesion. The group of vinyl-substituted silanes, however, generally features very adverse copolymerization parameters, which leads in turn, on incorporation into the polymer chain, to an unfavourable distribution of the monomer and, as a direct consequence thereof, to poor crosslinking characteristics (local regions of high crosslinking contrasting with regions devoid of crosslinking).

The abovementioned group of the γ-methacryloylsilanes, in contrast, generally has a considerably more favourable copolymerization behaviour here. Added to this is the acceptable storage stability of polymers modified in such a way. EP 327376 A2 describes, by way of example, the use of such comonomers for producing polyvinyl ester dispersions which serve to produce emulsion paints featuring improved wet adhesion. GB-B 1407827 describes the use of γ-methacryloyl-silane-modified polymers for architectural coatings, likewise featuring improved wet adhesion.

Nevertheless, the crosslinking rate of the polymers obtained is often inadequate. In order to ensure a sufficiently rapid curing in spite of this it is therefore often necessary to switch to the trimethoxy-substituted derivative, since only there is the hydrolysis rate acceptable. Moreover, this methoxy derivative must be incorporated into the copolymer at a relatively high percentage fraction. The consequence of that is a high VOC loading with methanol. Alternatively, catalysts based on titanium alkoxide or on tin must be added additionally, as for example in WO 97/12940 A1, and/or higher temperatures must be employed in the curing step.

For a number of years now silanes have been available in which the silicon atom substituted by alkoxy or OH groups is joined directly via a methylene bridge to an unsaturated hydrocarbon radical which contains one or more ethylenically unsaturated carbon bonds, it also being possible for the hydrogen radicals of the methylene bridge to have been replaced by alkyl and/or aryl radicals, and a C═C double bond is positioned a to the Si atom (hereinbelow: α-silanes). The structural feature of these compounds as compared with conventional γ-silanes with a propyl bridge (—C₃H₆—) is that only one methylene unit (—CH₂—) separates the free-radically polymerizable methacryloyl group from the silane-crosslinking alkoxysilyl group.

Ethylenically unsaturated α-silanes are known as comonomers for silane-modified polyvinyl acetals from DE 10140131 A1 and lead to an improvement in the adhesion of polyvinyl acetals. EP 1308468 A1 describes copolymers which in addition to vinyl ester and/or acrylate units also contain polysiloxane, ethylenically unsaturated silanes and epoxide functions. The silane fraction serves in that case to improve the wet adhesion of the copolymers.

It was an object of the invention to provide crosslinkable polymers which are distinguished, by comparison with conventional polymers which are crosslinkable via silane-functional groups, by the fact that they possess a reactivity better than that of conventional systems without detriment to the storage stability as a result.

It has now surprisingly been found that ethylenically unsaturated α-silanes are suitable for preparing aqueous, silane-crosslinking copolymers which exhibit relatively high crosslinking reactivity in association with a storage stability which matches that of the existing systems. In this way it is possible to prepare alkoxysilane-functional copolymers which on account of the improved crosslinking properties permit a lower silane content in the copolymer, and hence allow toxic, methoxy-substituted silanes to be replaced by the harmless ethoxy-substituted silanes, without an accompanying, intolerable loss of crosslinking reactivity, and hence which score significantly better in the VOC balance.

The invention provides crosslinkable, silane-modified copolymers in the form of their aqueous polymer dispersions or water-redispersible polymer powders obtainable by means of free-radically initiated copolymerization in aqueous medium of ethylenically unsaturated monomers with a post-crosslinking ethylenically unsaturated silane comonomer, and, if desired, subsequent drying of the resultant polymer dispersion, characterized in that

a) one or more monomers from the group consisting of vinyl esters of unbranched or branched alkylcarboxylic acids having 1 to 15 carbon atoms, methacrylic esters and acrylic esters of alcohols having 1 to 15 carbon atoms, vinylaromatics, vinyl ethers, olefins, dienes and vinyl halides are copolymerized with
b) 0.1 to 50% by weight, based on the total weight of a) and b), of one or more ethylenically unsaturated α-silanes.

Preferred vinyl esters are vinyl acetate, vinyl propionate, vinyl butyrate, vinyl-2-ethylhexanoate, vinyl laurate, 1-methylvinyl acetate, vinyl pivalate and vinyl esters of α-branched monocarboxylic acids having 9 to 13 carbon atoms, examples being VeoVa9® or VeoVa10® (trade names of Shell). Particular preference is given to vinyl acetate.

Suitable methacrylic esters or acrylic esters are esters of unbranched or branched alcohols having 1 to 15 carbon atoms such as methyl acrylate, methyl methacrylate, ethyl acrylate, ethyl methacrylate, propyl acrylate, propyl methacrylate, n-butyl acrylate, n-butyl methacrylate, 2-ethylhexyl acrylate and norbornyl acrylate. Preference is given to methyl acrylate, methyl methacrylate, n-butyl acrylate and 2-ethylhexyl acrylate.

Examples of olefins and dienes are ethylene, 1-alkylethylenes having a C₁ to C₆ alkyl radical, propylene and 1,3-butadiene. Preference is given to ethylene and 1,3-butadiene. Preferred vinylaromatics are styrene, alpha-methylstyrene, the isomeric vinyltoluenes and vinylxylenes, and divinylbenzenes. Particular preference is given to styrene. Among the vinyl halogen compounds mentioned may be made of vinyl chloride, vinylidene chloride, and also tetrafluoroethylene, difluoroethylene, hexylperfluoroethylene, 3,3,3-trifluoropropene, perfluoropropyl vinyl ether, hexafluoropropylene, chlorotrifluoroethylene and vinyl fluoride. Particular preference is given to vinyl chloride. One example of a preferred vinyl ether is methyl vinyl ether.

If desired it is also possible to copolymerize 0.05% to 20% by weight, preferably 1% to 10% by weight, based on the total weight of a) and b), of auxiliary monomers. Examples of auxiliary monomers are ethylenically unsaturated monocarboxylic and dicarboxylic acids, preferably acrylic acid, methacrylic acid, fumaric acid and maleic acid; ethylenically unsaturated carboxamides and carbonitriles, preferably acrylamide and acrylonitrile; mono esters and diesters of fumaric acid and maleic acid such as the diethyl and diisopropyl esters, and also maleic anhydride, ethylenically unsaturated sulphonic acids and their salts, preferably vinylsulphonic acid and 2-acrylamido-2-methylpropansulphonic acid. Further examples are pre-crosslinking comonomers such as polyethylenically unsaturated comonomers, examples being divinyl adipate, diallyl maleate, allyl methacrylate or triallyl cyanurate, or post-crosslinking comonomers, examples being acrylamidoglycolic acid (AGA), methylacrylamidoglycolic acid methyl ester (MAGME), N-methylolacrylamide (NMA), N-methylolmethacrylamide (NMMA), N-methylolallylcarbamate, alkyl ethers such as isobutoxy ether or esters of N-methylolacrylamide, of N-methylolmethacrylamide and of N-methylolallyl carbamate. Also suitable are epoxide-functional comonomers such as glycidyl methacrylate and glycidyl acrylate.

Particularly preferred comonomers a) are one or more monomers from the group of vinyl acetate, vinyl esters of α-branched monocarboxylic acids having 9 to 11 carbon atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, styrene and 1,3-butadiene. Particularly preferred comonomers a) are also mixtures of vinyl acetate and ethylene; mixtures of vinyl acetate, ethylene and a vinyl ester of α-branched monocarboxylic acids having 9 to 11 carbon atoms; mixtures of n-butyl acrylate and 2-ethylhexyl acrylate and/or methyl methacrylate; mixtures of styrene and one or more monomers from the group of methyl acrylate, ethyl acrylate, propyl acrylate, n-butyl acrylate and 2-ethylhexyl acrylate; mixtures of vinyl acetate and one or more monomers from the group of methyl acrylate, ethyl acrylate, propyl acrylate, n-butyl acrylate, 2-ethylhexyl acrylate and, if desired, ethylene; mixtures of 1,3-butadiene and styrene and/or methyl methacrylate; it is also possible, if desired, for the stated mixtures to include one or more of the abovementioned auxiliary monomers.

The monomer selection and/or the selection of the weight fractions of the comonomers are made such as to result in general in a glass transition temperature, Tg of ≦60° C., preferably −30° C. to +40° C. The polymer glass transition temperature Tg can be ascertained in a known way by means of differential scanning calorimetry (DSC). The Tg can also be calculated approximately in advance by means of the Fox equation. According to Fox T. G., Bull. Am. Physics Soc. 1, 3, page 123 (1956) the following is the case: 1/Tg=x1/Tg1+x2/Tg2+ . . . +xn/Tgn, xn being the mass fraction (% by weight/100) of the monomer n, and Tgn being the glass transition temperature, in kelvins of the homopolymer of the monomer n. Tg values for homopolymers are listed in Polymer Handbook 2nd Edition, J. Wiley & Sons, New York (1975).

By α-silanes are meant silanes of the kind in which the silicon atom substituted by an alkoxy or OH group is attached directly via a methylene bridge to an unsaturated hydrocarbon radical which has one or more ethylenically unsaturated carbon bonds, it also being possible for the hydrogen radicals of the methylene bridge to have been replaced by alkyl and/or aryl radicals, and a C═C double bond is positioned a to the Si atom.

Preferred α-silanes are those of the general formula (I) (R¹O)₃₋ₙ(R²)ₙSi—CR³₂—X (I), R¹, R² and R³ being identical or different and each being hydrogen or a linear, branched or cyclic aliphatic or aromatic hydrocarbon radical of between 1 and 18 carbon atoms, it being possible for n to denote the values 0, 1 or 2, and X being a radical having 2 to 20 hydrocarbon atoms and containing an ethylenically unsaturated group positioned a to the Si atom.

Preferred radicals R¹ and R² are unsubstituted alkyl groups having 1 to 6 carbon atoms, the phenyl radical and hydrogen. Particular preference for R¹ is given to the methyl radical and the ethyl radical. R² is preferably hydrogen, methyl or ethyl. R³ is preferably hydrogen. The radical X can be linear, branched or cyclic. Besides the double bond there may also be further functional groups present, which are generally inert with respect to an olefinic polymerization, examples being halogen, carboxy, sulphinato, sulphonato, amino, azido, nitro, epoxy, alcohol, ether, ester, thioether and thioester groups and also aromatic isocyclic and heterocyclic groups. Preferred examples of X are monounsaturated C₁ to C₁₀ radicals; the most preferred radicals X are the acryloyl radical and the methacryloyl radical.

Preference is given to α-methacryloyloxymethylmethoxydimethyl-silane, α-methacryloyloxymethyldimethoxymethylsilane and α-methacryloyloxymethyltrimethoxysilane. Particular preference is given to α-methacryloyloxymethylethoxydimethylsilane, α-methacryloyloxymethyldiethoxymethylsilane and α-methacryloyloxymethyltriethoxysilane.

The α-silanes b) are preferably copolymerized in an amount of 0.1% to 20% by weight, based on the total weight of a) and b).

The copolymers are prepared by the known techniques of bulk, solution, suspension or emulsion polymerization. In the case of bulk or solution polymerization dispersion takes place in an aqueous system after polymerization has taken place. Preferably, however, the polymerization is carried out by the methodology of emulsion polymerization or related techniques such as those of suspension, dispersion or miniemulsion polymerization: in this embodiment the reaction temperatures are between 0° C. and 100° C., preferably between 5° C. and 80° C., more preferably between 30° C. and 70° C. The pH of the dispersion medium is between 2 and 9, preferably between 4 and 8. In one particularly preferred embodiment it is between 6.5 and 7.5. The adjustment of the pH before the beginning of the reaction can be accomplished by means of hydrochloric acid or aqueous sodium hydroxide solution.

The polymerization may be carried out batchwise or continuously, with some or all of the constituents of the reaction mixture being included in the initial charge, with part of some constituents of the reaction mixture being included in the initial charge and part metered in subsequently, or by the metering method without an initial charge. All metered additions are made preferably at the rate at which the respective component is consumed. The procedure adopted in one preferred embodiment is that part of the comonomers a) are included in the initial charge before the start of the polymerization, and the remainder are metered in after the initiation, and the α-silanes b) are metered in entirely after the initiation.

The initiation of the polymerization is accomplished by means of the typical water-soluble initiators or redox initiation combinations. Examples of initiators are the sodium, potassium and ammonium salts of peroxodisulphuric acid, hydrogen peroxide, tert-butyl peroxide, tert-butyl hydroperoxide, potassium peroxodiphosphate, tert-butyl peroxopivalate, cumene hydroperoxide, isopropylbenzene monohydroperoxide and azobisisobutyronitrile. The stated initiators are used preferably in amounts of 0.01% to 4.0% by weight, based on the total weight of the monomers. Redox initiator combinations used are abovementioned initiators in conjunction with a reducing agent. Suitable reducing agents are sulphites and bisulphites of monovalent cations, sodium sulphite for example, the derivatives of sulphoxylic acid such as zinc or alkali metal formaldehyde-sulphoxylates, an example being sodium hydroxymethanesulphinate, and ascorbic acid. The amount of reducing agent is preferably 0.15% to 3% by weight of the monomer amount employed. In addition it is possible to introduce small amounts of a metal compound which is soluble in the polymerization medium and whose metal component is redox-active under the polymerization conditions, examples being compounds based on iron or on vanadium. One particularly preferred initiator system composed of the aforementioned components is the tert-butyl hydroperoxide/sodium hydroxymethanesulphinate/Fe(EDTA)^{2+/3+} system.

As dispersants it is possible to employ all protective colloids and/or emulsifiers that are typically used. Examples of suitable protective colloids include partially hydrolysed polyvinyl alcohols, polyvinylpyrrolidones, polyvinyl acetals, starches, celluloses and their carboxymethyl, methyl, hydroxyethyl and hydroxypropyl derivatives. Suitable emulsifiers include anionic, cationic and nonionic emulsifiers, examples being anionic surfactants, such as alkyl sulphates having a chain length of 8 to 18 carbon atoms, alkyl or alkylaryl ether sulphates having 8 to 18 carbon atoms in the hydrophobic radical and up to 60 ethylene oxide or propylene oxide units, alkyl- or alkylarylsulphonates having 8 to 18 carbon atoms, esters and monoesters of sulphosuccinic acid with monohydric alcohols or alkylphenols, or nonionic surfactants such as alkyl polyglycol ethers or alkylaryl polyglycol ethers having up to 60 ethylene oxide and/or propylene oxide units.

The protective colloids and/or emulsifiers are added generally in an amount totaling 1% to 20% by weight, based on the total weight of the monomers a) and b), in the polymerization.

Following reaction, the dispersions obtained have a pH of between 4 and 9, in particular between 7 and 8. This pH can be varied subsequently, however, by means of hydrochloric acid or aqueous sodium hydroxide solution. To regulate the pH it is also possible, before the beginning of the reaction or after reaction has been concluded, to introduce common organic or inorganic buffers, examples being buffers based on hydrogen carbonate or hydrogen phosphate. The solids content of the dispersion, following polymerization or following the taking up of a bulk or solution polymer in water, is between 25% and 75% by weight, in particular between 30% and 60% by weight, very particularly between 45% and 55% by weight. The size of the dispersed polymer particles is determined by factors including the identity and amount of the dispersant used, the mode and duration of shearing, and any hydrophobic auxiliaries added. Typically the diameters of the polymer particles are between 10 and 5000 nm, particularly between 50 and 1000 nm. Very particular preference is given to particle sizes between 100 and 250 nm.

To prepare the water-redispersible polymer powders the aqueous dispersions, following addition of protective colloids as spraying aids if desired, are dried, by means for example of fluid-bed drying, freeze drying or spray drying. The dispersions are preferably spray-dried. Spray drying in this case takes place in typical spray-drying units, it being possible for the atomization to be effected by means of single-fluid, two-fluid or multi-fluid nozzles or using a rotating disc. The exit temperature chosen is generally in the range from 45° C. to 120° C., preferably 60° C. to 90° C., depending on unit, resin Tg and desired degree of drying.

In the course of drying to form water-redispersible polymer powders it is usual to use a spraying aid in a total amount of 3% to 30% by weight, based on the polymeric constituents of the dispersion. In other words, the total amount of protective colloid prior to the drying operation should be at least 3% to 30% by weight, based on the polymer fraction; it is preferred to use 5% to 20% by weight based on the polymer fraction.

Suitable spraying aids are partially hydrolysed polyvinyl alcohols; polyvinylpyrrolidones; polysaccharides in water-soluble form such as starches (amylose and amylopectin), celluloses and their carboxymethyl, methyl, hydroxyethyl and hydroxypropyl derivatives; proteins such as casein or caseinate, soya protein, gelatin; ligninsulphonates; synthetic polymers such as poly(meth)acrylic acid, copolymers of (meth)acrylates with carboxyl-functional comonomer units, poly(meth)acrylamide, polyvinylsulphonic acids and their water-soluble copolymers; melamine-formaldehyde sulphonates, naphthalene-formaldehyde sulphonates, styrene-maleic acid copolymers and vinyl ether-maleic acid copolymers.

In the course of spraying an amount of up to 1.5% by weight of antifoam, based on the base polymer, has proved to be favourable in numerous instances. In order to increase the storability by improving the blocking stability, particularly in the case of powders having a low glass transition temperature, the powder obtained can be furnished with an antiblocking (anticaking) agent, preferably at up to 30% by weight, based on the total weight of polymeric constituents. Examples of antiblocking agents are Ca and/or Mg carbonate, talc, gypsum, silica, kaolins and silicates having particle sizes preferably in the range from 10 nm to 10 μm.

The copolymers thus obtained possess good storage stabilities in aqueous dispersion or redispersion and are distinguished by the fact that, following application, they possess the capacity to cure at low temperatures in tandem with rapid cure rates. Curing here is realized through the formation of a three-dimensional network composed of Si—O—Si bonds.

The crosslinkable, silane-modified copolymers in the form of their aqueous polymer dispersions or water-redispersible polymer powders can be employed in the areas of application that are typical for such systems: for example, in chemical products for construction, alone or in conjunction with hydraulically setting binders such as cements (Portland, aluminate, trass, slag, magnesia and phosphate-cement), Gypsum and water glass, for producing construction adhesives, especially tile adhesives and exterior insulation and finishing adhesives, renders, filling compounds, trowel-applied flooring compounds, levelling compounds, non-shrink grouts, jointing mortars and paints, and also as binders for coating materials and bonding agents or as coating materials and binders for textiles, fibres, wood and paper.

The examples below serve to elucidate further the invention.

Unless indicated otherwise, all amounts and percentages are based on weight. All reactions took place in an inert atmosphere (nitrogen). The particle sizes of the dispersions obtained were determined by means of a particle size measuring instrument (Coulter counter). pH values were determined using a combination electrode.

### EXAMPLE 1

### Polymer Dispersion 1 (PD1)

In a 1000-ml polymerization vessel with anchor stirrer
21.8 g of n-butyl acrylate
11.4 g of styrene
83.4 ml of water
1.7 g of acrylic acid
0.4 g of sodium dodecyl sulphate
0.16 g of sodium vinylsulphonate

10 mg each of iron(II) sulphate and EDTA disodium salt were adjusted to a pH of 6.5 and heated at 40° C. with stirring (200 rpm) (initial charge).

In a first vessel (feed 1a) a 10% strength by weight solution of tert-butyl hydroperoxide in water was prepared.

In a second vessel (feed 1b) a 5% strength by weight solution of sodium hydroxymethanesulphinate in water was prepared.

In a third vessel (feed 2) a monomer emulsion of
169.3 ml of water
5.10 g of acrylic acid
29.0 g of α-methacryloyloxymethyltriethoxysilane
13.6 g of sodium dodecyl sulphate
197 g of n-butyl acrylate
103 g of styrene
   was prepared.

Feeds 1a and 1b were started, with a metering rate of 105 μl/min, and the initial charge was polymerized at 40° C. for 20 minutes. Then feed 2 was started, with a metering rate of 4 ml/min, and the monomer emulsion was metered in continuously over the course of 165 minutes. Finally, polymerization was continued for 1 h. The batch was then cooled to room temperature. The polymer dispersion had a solids content of 53.5% with a pH of 7.6. The Tg was +2° C. The average particle size as determined by means of light scattering was 140 nm with a polydispersity of close to 1.

### EXAMPLE 2

### Polymer Dispersion 2 (PD2)

As Example 1, but polymerization took place at 20° C. over a period totaling 6.5 h. The composition of feed 2 was as follows:

| | | |
|---|---|---|
| Feed 2: | Water | 169.3 g |
| | Acrylic acid | 5.1 g |
| | α-Methacryloyloxymethyltriethoxysilane | 7.0 g |
| | SDS | 13.6 g |
| | n-Butyl acrylate | 196.5 g |
| | Styrene | 103.0 g |

The resultant polymer dispersion had a solids content of 48% with a pH of 7.6. The average particle size was 130 nm with a polydispersity of 1.1.

### EXAMPLE 3

### Polymer Dispersion 3 (PD3)

As Example 1, but the composition of feed 2 was as follows:

| | | |
|---|---|---|
| Feed 2: | Water | 169.3 g |
| | Acrylic acid | 5.1 g |
| | α-Methacryloyloxymethyltriethoxysilane | 7.0 g |
| | SDS | 13.6 g |
| | n-Butyl acrylate | 196.5 g |
| | Styrene | 103.0 g |

The resultant polymer dispersion had a solids content of 50% with a pH of 7.5. The average particle size was 150 nm with a polydispersity of 1.08. The Tg was −3° C.

### EXAMPLE 4

### Polymer Dispersion 4 (PD4)

As Example 1, but the composition of feed 2 was as follows:

| | | |
|---|---|---|
| Feed 2: | Water | 169.3 g |
| | Acrylic acid | 5.1 g |
| | α-Methacryloyloxymethyltriethoxysilane | 60 g |
| | SDS | 13.6 g |
| | n-Butyl acrylate | 196.5 g |
| | Styrene | 103.0 g |

The resultant polymer dispersion had a solids content of 50% with a pH of 7.5. The average particle size was 150 nm with a polydispersity of 1.08. The Tg was 0° C.

### EXAMPLE 5

### Polymer Dispersion 5 (PD5)

As Example 1, but the composition of feed 2 was as follows:

| | | |
|---|---|---|
| Feed 2: | Water | 169.3 g |
| | Acrylic acid | 5.1 g |
| | α-Methacryloyloxymethyldimethylmono- | 60.7 g |
| | methoxysilane | |
| | SDS | 13.6 g |
| | n-Butyl acrylate | 196.5 g |
| | Styrene | 103.0 g |

The resultant polymer dispersion had a solids content of 53% with a pH of 7.6. The average particle size was 147 nm with a polydispersity of 1.13. The Tg was −3° C.

### EXAMPLE 6

### Polymer Dispersion 6 (PD6)

As Example 1, but the composition of feed 2 was as follows:

| | | |
|---|---|---|
| Feed 2: | Water | 169.3 g |
| | Acrylic acid | 5.1 g |
| | α-Methacryloyloxymethyldimethylmono- | 29.0 g |
| | methoxysilane | |
| | SDS | 13.6 g |
| | n-Butyl acrylate | 196.5 g |
| | Styrene | 103.0 g |

The resultant polymer dispersion had a solids content of 53.6% with a pH of 7.3. The average particle size was 150 nm with a polydispersity of 1.12. The Tg was +5° C.

### EXAMPLE 7

### Polymer Dispersion 7 (PD7)

As Example 1, but the composition of feed 2 was as follows:

| | | |
|---|---|---|
| Feed 2: | Water | 169.3 g |
| | Acrylic acid | 5.1 g |
| | α-Methacryloyloxymethyltriethoxysilane | 3.0 g |
| | SDS | 13.6 g |
| | n-Butyl acrylate | 196.5 g |
| | Styrene | 103.0 g |

The resultant polymer dispersion had a solids content of 50.0% with a pH of 7.6. The average particle size was 147 nm with a polydispersity of 1.08.

### EXAMPLE 8

### Polymer Dispersion 8 (PD8)

As Example 1, but the composition of feed 2 was as follows:

| | | |
|---|---|---|
| Feed 2: | Water | 169.3 g |
| | Acrylic acid | 5.1 g |
| | α-Methacryloyloxymethyltriethoxysilane | 29.0 g |
| | SDS | 13.6 g |
| | n-Butyl acrylate | 196.5 g |
| | Styrene | 103.0 g |

The resultant polymer dispersion had a solids content of 51.4% with a pH of 7.8. The average particle size was 156 nm with a polydispersity of 1.12.

### EXAMPLE 9

### Polymer Dispersion 9 (PD9)

As Example 1, but the composition of feed 2 was as follows:

| | | |
|---|---|---|
| Feed 2: | Water | 169.3 g |
| | Acrylic acid | 5.1 g |
| | α-Methacryloyloxymethyldimethylmono- | 29.0 g |
| | ethoxysilane | |
| | SDS | 13.6 g |
| | n-Butyl acrylate | 196.5 g |
| | Styrene | 103.0 g |

The resultant polymer dispersion had a solids content of 51.4% with a pH of 7.8. The average particle size was 156 nm with a polydispersity of 1.12.

### EXAMPLE 10

### Polymer Dispersion 10 (PD10)

As Example 1, but the polymer latex was stabilized by means of a 20% strength by weight aqueous solution of a poly vinyl alcohol (degree of hydrolysis 88 mol %, Höppler viscosity 4 mPas). The compositions of initial charge and feed 2 were as follows:

| | | |
|---|---|---|
| Initial charge: | 7.3 g of n-butyl acrylate | |
| | 3.8 g of styrene | |
| | 66 ml of water | |
| | 1.7 g of acrylic acid | |
| | 10.6 ml of polyvinyl alcohol (20% strength) | |
| | 0.10 g of sodium vinylsulphonate | |
| | 20 mg each of iron(II) sulphate and EDTA | |
| | disodium salt | |
| Feed 2: | Water | 134 g |
| | Acrylic acid | 5.0 g |
| | α-Methacryloyloxymethyltriethoxysilane | 29.0 g |
| | Polyvinyl alcohol (20% strength) | 354.4 ml |
| | n-Butyl acrylate | 65.5 g |
| | Styrene | 34.3 g |

The resultant polymer dispersion had a solids content of 27% with a pH of 7.5. The average particle size was 116 nm with a polydispersity of 1.12.

### COMPARATIVE EXAMPLE 1

### Comparative Dispersion 1 (CD1)

As Example 1, but the composition of feed 2 was as below. The resulting dispersion (comparative dispersion CD1) was prepared for comparison purposes.

| | | |
|---|---|---|
| Feed 2: | Water | 169.3 g |
| | Acrylic acid | 5.1 g |
| | SDS | 13.6 g |
| | n-Butyl acrylate | 196.5 g |
| | Styrene | 103.0 g |

The resultant polymer dispersion had a solids content of 49% with a pH of 8. The average particle size was 143 nm with a polydispersity of 1.08.

### COMPARATIVE EXAMPLE 2

### Comparative Dispersion 2 (CD2)

As Example 1, but the composition of feed 2 was as below. The resulting dispersion (comparative dispersion CD2) was prepared for comparison purposes.

| | | |
|---|---|---|
| Feed 2: | Water | 169.3 g |
| | Acrylic acid | 5.1 g |
| | γ-Methacryloyloxypropyltrimethoxysilane | 29.0 g |
| | SDS | 13.6 g |
| | n-Butyl acrylate | 196.5 g |
| | Styrene | 103.0 g |

The resultant polymer dispersion had a solids content of 50.0% with a pH of 7.5. The average particle size was 146 nm with a polydispersity of 1.08.

### Stability Test

In order to assess the storage stabilities of the dispersion a series of tests was conducted.

First, the alcohol released as a result of premature hydrolysis was determined in the gas phase over the dispersion by means of headspace GC/MS: on the basis of the slow increase in the peaks assignable to the respective alcohol, the GC/MS suggests a gradual hydrolysis of the Si(OR) moiety. However, this has no effect at all on the stability of the dispersions or on their film formation and crosslinking properties.

At regular intervals the viscosity of the dispersions was determined in order to gauge the extent of any prior crosslinking of the polymers in dispersion. Only an insignificant change in viscosity was apparent here over the course of a 4-month measurement period.

### Crosslinking Tests

In order to determine crosslinking kinetics of the different silane-modified dispersions, a number of samples for a series of dispersions were coated out using a 100 μm doctor blade and stored at 50° C. for varying periods of time. After defined times the change in the gel content was measured by determining the fractions soluble in acetone at room temperature within 20 h. All dispersions had the same fraction of silane in the polymer and were of equal age.

The table below gives an overview of the results. Naturally, the most rapid increase is found in the case of the trialkoxy-substituted preparations PD1 and CD2. A comparison of PD1 (alpha-triethoxy) against CD2 (gamma-trimethoxy) clearly shows the increased crosslinking rate of dispersion PD1.

| | Increase in % gel content after minutes | | | | | | | | |
|---|---|---|---|---|---|---|---|---|---|
| PDX | 2 | 5 | 10 | 15 | 30 | 60 | 80 | 100 | 120 |
| PD1 | 11 | 13 | 16 | 23 | 27 | 30 | 33 | 36 | 40 |
| PD6 | 2 | 4 | 5 | 5 | 5 | 6 | 6 | 7 | 7 |
| PD8 | 2 | 7 | 12 | 13 | 13 | 13 | 17 | 21 | 25 |
| PD9 | 1 | 3 | 5 | 5 | 6 | 6 | 6 | 5 | 7 |
| CD1 | 0 | 0 | 0 | 0 | 0 | 0 | 0 | 0 | 0 |
| CD2 | 1 | 2 | 6 | 8 | 9 | 14 | 27 | 32 | 37 |

1.-10. (canceled)

11. A crosslinkable, silane-modified copolymer in the form of an aqueous polymer dispersion or water-redispersible polymer powder, comprising a free-radically polymerized polymer polymerized in an aqueous medium and containing polymerized residues of at least one ethylenically unsaturated monomer and a post-crosslinking ethylenically unsaturated α-silane comonomer, wherein
a) one or more monomers selected from the group consisting of vinyl esters of optionally branched C₁₋₁₅ alkylcarboxylic acids, methacrylic esters and acrylic esters of C₁₋₁₅ alcohols, vinylaromatics, vinyl ethers, olefins, dienes and vinyl halides, are copolymerized with
b) 0.1 to 50% by weight, based on the total weight of a) and b), of one or more ethylenically unsaturated α-silanes.

12. A crosslinkable, silane-modified copolymer of claim 11, wherein at least one comonomer a) is selected from the group consisting of vinyl acetate, vinyl esters of α-branched C₉₋₁₁ monocarboxylic acids, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, styrene and 1,3-butadiene.

13. A crosslinkable, silane-modified copolymer of claim 11, wherein at least one comonomer b) is an α-silane of the formula (I) (R¹O)₃₋ₙ(R²)ₙSi—CR³₂—X, R¹, R² and R³ being identical or different and each being hydrogen or a linear, branched or cyclic aliphatic or aromatic hydrocarbon radical of between 1 and 18 carbon atoms, n is 0, 1 or 2, and X is a radical having 2 to 20 carbon atoms and containing an ethylenically unsaturated group positioned α to the Si atom.

14. A crosslinkable, silane-modified copolymer of claim 13, wherein radicals R¹ and R² are selected from the group consisting of unsubstituted alkyl groups having 1 to 6 carbon atoms, the phenyl radical and hydrogen, R³ is hydrogen, and the radical X is a (meth)acryloyl radical.

15. A crosslinkable, silane-modified copolymer of claim 13, wherein α-silane(s) copolymerized are one or more selected from the group consisting of α-methacryloyloxymethylmethoxydimethylsilane, α-methacryloyloxymethyldimethoxymethylsilane, α-methacryloyloxymethyltrimethoxysilane, α-methacryloyloxymethylethoxydimethylsilane, α-methacryloyloxymethyldiethoxymethylsilane and α-methacryloyloxymethyltriethoxysilane.

16. A process for preparing a crosslinkable, silane-modified copolymer of claim 11, wherein the polymerization is a bulk, solution, suspension, emulsion or miniemulsion polymerization.

17. The process of claim 16, wherein the polymer dispersions are dried by means of spray drying to form a water-redispersible polymer powder.

18. A chemical product used in construction, comprising a hydraulically settable inorganic binder and a cross-linkable, silane-modified copolymer of claim 11.

19. A coating or binder composition, comprising at least one crosslinkable silane-modified copolymer of claim 11.

20. A coated or bound substrate comprising a textile, fibre, wood, or paper product, wherein a coating or binder comprising at least one crosslinkable, silane-modified copolymer of claim 11 is applied to said substrate.
